(19) United States
(12) Patent Application Publication
(10) Pub. No.: US 2015/0100506 A1
(43) Pub. Date: Apr. 9, 2015

(54) SYSTEMS AND METHODS TO REPORT VEHICLE OWNERSHIP INFORMATION

(71) Applicant: STATE FARM MUTUAL AUTOMOBILE INSURANCE COMPANY, Bloomington, IL (US)

(72) Inventors: Todd Binion, Bloomington, IL (US); Kelly S. Minter, Normal, IL (US); Heidi Brown-McCreery, Bloomington, IL (US); Michael Harris, Normal, IL (US); Jeremy Myers, Normal, IL (US); Brian Fields, Normal, IL (US); Joe Harr, Bloomington, IL (US)

(73) Assignee: STATE FARM MUTUAL AUTOMOBILE INSURANCE COMPANY, Bloomington, IL (US)

(21) Appl. No.: 14/047,268

(22) Filed: Oct. 7, 2013

(51) Int. Cl. G06Q 30/02

(52) U.S. Cl. CPC G06Q 30/0278
USPC 705/306

(57) ABSTRACT

A method for reporting vehicle ownership information includes receiving an enrollment from a customer, wherein the enrollment includes information identifying a vehicle and retrieving a plurality of condition data corresponding to the vehicle from one or more databases. The method further includes analyzing the existing condition data and the additional condition data to establish a vehicle condition trend. The vehicle condition trend reflects changes in a condition of the vehicle, wherein the condition of the vehicle relates to at least one of a quality or a value of the vehicle. Still further, the method includes generating a vehicle ownership report, wherein the vehicle ownership report includes indications of the vehicle condition trend, and communicating the vehicle ownership report to a remote computing device for presentation to the customer.

### TECHNICAL FIELD

The present disclosure generally relates to assessing the condition of a vehicle and, more particularly, to a method for gathering and analyzing condition related data.

### BACKGROUND

Often vehicle owners are unable to accurately assess the current condition of the vehicles they own, because the only information available is maintenance/repair records or vehicle gauge readings. It is impossible to accurately assess the condition of a vehicle from such general information, and, as a result, vehicle owners are often faced with unexpected repair costs, abnormal vehicle behavior, and/or unnecessary vehicle depreciation. Vehicle owners who would address potential vehicle issues, if aware of any issues, are unable to proactively avoid mechanical problems and/or vehicle depreciation because of a lack of relevant information.

Moreover, vehicle owners who own a used vehicle are often unaware of relevant information regarding the past condition of the vehicle. Prior to buying the used vehicle, a vehicle owner does not know how the vehicle was driven (e.g. severe acceleration and braking, towing a trailer, etc.), where the vehicle was driven (rural areas, urban areas, the “salt belt,” etc.), and under what conditions was the vehicle driven (e.g. traffic, highway, snow, etc.).

### SUMMARY

In one embodiment, a computer-implemented method for reporting vehicle ownership information comprises receiving, via a computer network, an enrollment from a customer, wherein the enrollment includes information identifying a vehicle, retrieving existing condition data corresponding to the vehicle from a condition database, wherein a device inside the vehicle generates at least some of the existing condition data while the vehicle is being operated, and gathering, via the computer network, additional condition data corresponding to the vehicle, wherein at least some of the additional condition data is generated at a time after the generation of the existing condition data. The method further comprises analyzing, with one or more processors, the existing condition data and the additional condition data to establish a vehicle condition trend, wherein the vehicle condition trend reflects changes in a condition of the vehicle, wherein the condition of the vehicle relates to at least one of a quality or a value of the vehicle, generating, with one or more processors, a vehicle ownership report, wherein the vehicle ownership report includes indications of the vehicle condition trend, and communicating, via the computer network, the vehicle ownership report to a remote computing device for presentation to the customer.

In another embodiment, a computer-implemented method for reporting vehicle condition information on a computing device, including a display device and a user interface, comprises receiving, via the user interface, a vehicle enrollment, wherein the enrollment includes information identifying a vehicle, generating, with one or more processors, a vehicle condition query, wherein the vehicle condition query includes the information identifying the vehicle, and sending, via a network interface at the computing device, the vehicle condition query to a server. Further, the method comprises receiving, via the network interface at the computing device, information indicative of a vehicle condition trend, wherein the vehicle condition trend reflects changes in a condition of the vehicle, wherein the condition of the vehicle relates to at least one of a quality or a value of the vehicle, and wherein the condition of the vehicle is based on an analysis of condition data generated by devices inside the vehicle while the vehicle is being operated. Still further, the method comprises rendering, with one or more processors, an image of at least some of the information indicative of the vehicle condition trend, and presenting, via the display device, the image of at least some of the information indicative of the vehicle condition trend.

In yet another embodiment, a computer device for reporting vehicle ownership information, the computer device comprises one or more processors and one or more non-transitory memories coupled to the one or more processors, wherein the one or more memories include computer executable instructions stored therein that, when executed by the one or more processors, cause the one or more processors to: receive, via a computer network, an enrollment from a customer, wherein the enrollment includes information identifying a vehicle, retrieve existing condition data corresponding to the vehicle from a condition database, wherein a device inside the vehicle generates at least some of the existing condition data while the vehicle is being operated, and gather, via the computer network, additional condition data corresponding to the vehicle, wherein at least some of the additional condition data is generated at a time after the generation of the existing condition data. Further, when executed by the one or more processors, the computer executable instructions cause the one or more processors to: analyze, with one or more processors, the existing condition data and the additional condition data to establish a vehicle condition trend, wherein the vehicle condition trend reflects changes in a condition of the vehicle, wherein the condition of the vehicle relates to at least one of a quality or a value of the vehicle, generate, with one or more processors, a vehicle ownership report, wherein the vehicle ownership report includes indications of the vehicle condition trend, and communicate, via the computer network, the vehicle ownership report to a remote computing device for presentation to the customer.

### BRIEF DESCRIPTION OF THE DRAWINGS

FIG. 1 illustrates an example system in which a condition report server may assess the condition of a vehicle.

FIG. 2 illustrates an example server that can be implemented as the condition report server illustrated in FIG. 1.

FIG. 3 illustrates an example end user device that can be implemented as one of the end user devices illustrated in FIG. 1.

FIG. 4 is a flow diagram of an example method for developing vehicle condition trends which can be implemented in the system illustrated in FIG. 1.

FIG. 5 is a flow diagram of an example method for reporting vehicle condition information which can be implemented in the system illustrated in FIG. 1.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______ ’ is hereby defined to mean . . . ” or a similar sentence, there is no intent to limit the meaning of that term, either expressly or by implication, beyond its plain or ordinary meaning, and such terms should not be interpreted to be limited in scope based on any statement made in any section of this patent (other than the language of the claims). To the extent that any term recited in the claims at the end of this patent is referred to in this patent in a manner consistent with a single meaning, that is done for the sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

As used herein, the term “vehicle” may refer to any of a number of motorized transportation devices. A vehicle may be a car, truck, bus, train, boat, plane, etc. Additionally, as used herein, the term “driver” may refer to any operator of a vehicle. A driver may be a car driver, truck driver, bus driver, train engineer, captain of a boat, pilot of an airplane, etc.

### System Overview

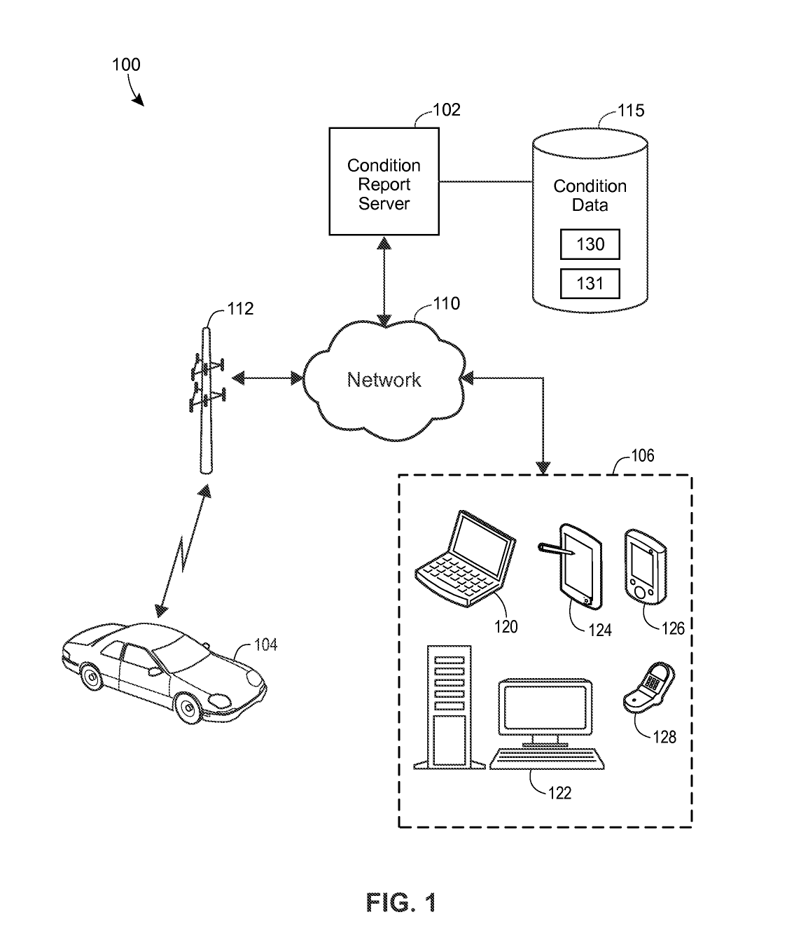

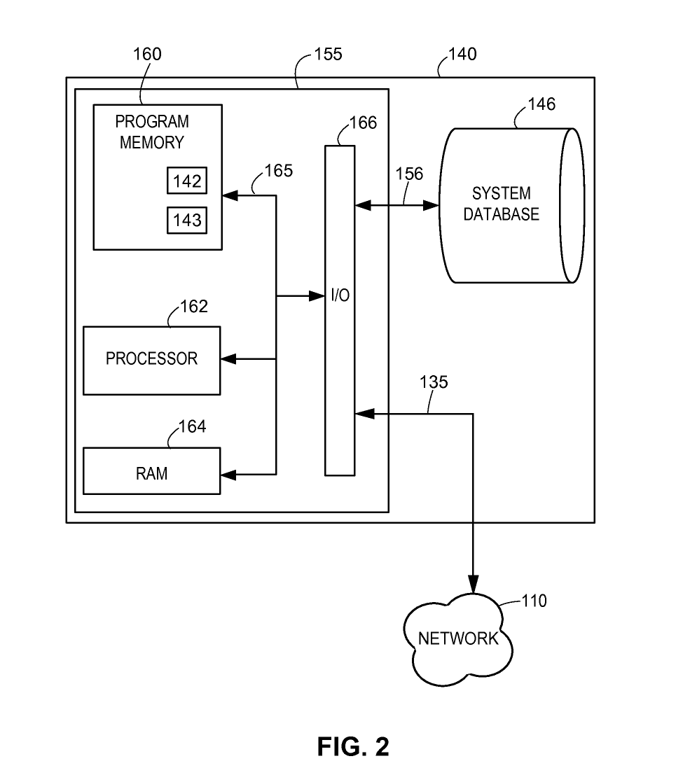

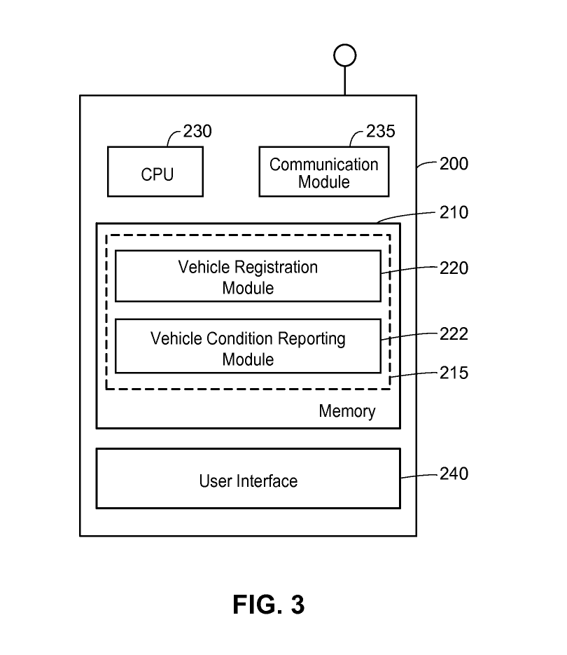

FIG. 1 illustrates an example system 100 in which the condition of a vehicle 104 can be accurately assessed and reported to an owner of the vehicle. A condition report server 102 and one or more end user devices 106 are communicatively coupled to a network 110. Additionally, the vehicle 104 is communicatively coupled to the network 110 via an antenna 112. The network 110 may be a proprietary network, a secure public internet, a virtual private network or some other type of network, such as dedicated access lines, plain ordinary telephone lines, satellite links, combinations of these, etc. Where the network 110 comprises the Internet, data communications may take place over the network 110 via an Internet communication protocol. Further details of an example condition report server and an example end user device are described with reference to FIG. 2 and FIG. 3, respectively.

In some implementations, the vehicle 104 may upload condition data to the condition report server 102 via the network 110. For example, an on-board computing device (not shown) or end user device disposed in the vehicle 104 may wirelessly upload data from braking, acceleration, motion, force, environment, image, etc. sensors, via one or more wireless interfaces (not shown), for assessing the condition of the vehicle 104. In turn, the condition report server 102 may store the condition data in a condition database 115 that is communicatively coupled to the condition report server 102. The condition database 115 may include an assortment of computer-readable media. By way of example and without limitation, computer-readable media may include both volatile and nonvolatile media, removable and non-removable media. In some implementations, the condition database 115 may include existing condition data 130 from previous vehicle owners and additional condition data 131 from the current vehicle owner.

Although the example system 100 is shown to include one condition report server 102 and five end user devices 106, it is understood that different numbers of servers and end user devices may be utilized. Furthermore, the processing performed by the condition report server 102 may be distributed among a plurality of servers in an arrangement known as “cloud computing,” in an implementation. This configuration may provide several advantages, such as enabling near real-time uploads and downloads of information as well as periodic uploads and downloads of information, for example.

FIG. 2 illustrates an example server 140 that may be implemented as a condition report server, such as the condition report server 102. The example server 140 includes a controller 155 that is operatively connected to the database 146 via a link 156, and it should be noted that, while not shown, additional databases may be linked to the controller 155 in a known manner. The controller 155 may include a program memory 160, a processor 162 (may be called a microcontroller or a microprocessor), a random-access memory (RAM) 164, and an input/output (I/O) circuit 166, all of which may be interconnected via an address/data bus 165. The program memory 160 may be configured to store computer-readable instructions that when executed by the processor 162 cause the server 140 to implement a server application 142 and a web server 143. The instructions for the server application 142 may cause the server 140 to implement the methods described herein.

While shown as a single block in FIG. 2, it will be appreciated that the server application 142 may include a number of different programs, modules, routines, and sub-routines that may collectively cause the server 140 to implement the server application 142. It should be appreciated that although only one microprocessor 162 is shown, the controller 155 may include multiple microprocessors 162. Similarly, the memory of the controller 155 may include multiple RAMs 164 and multiple program memories 160. Further, while the instructions for the server application 142 and web server 143 are shown being stored in the program memory 160, the instructions may additionally or alternatively be stored in the database 146 and/or RAM 164. Although the I/O circuit 166 is shown as a single block, it should be appreciated that the I/O circuit 166 may include a number of different types of I/O circuits. The RAM(s) 164 and program memories 160 may be implemented as semiconductor memories, magnetically readable memories, and/or optically readable memories, for example. The controller 155 may also be operatively connected to the network 130 via a link 135.

FIG. 3 illustrates an example end user device 200 capable of reporting vehicle condition information to a customer, as discussed below. The end user device 200 may be implemented as one of the end user devices 106, for example. The end user device 200 includes a computer readable memory 210 in the form of volatile and/or nonvolatile memory such as read only memory (ROM) and random access memory (RAM). The memory 210 may store a vehicle ownership tool 215 including a vehicle enrollment module 220 and a vehicle condition reporting module 222 to be executed by a CPU 230. In one implementation, the vehicle ownership tool 215 may be available at an online application store disposed at an application server (not shown), for example. A user may retrieve a copy of the vehicle ownership tool 215 from the server and “install” the retrieved copy of the vehicle ownership tool 215 on the end user device 200.

In other implementations, the end user device 200 is capable of executing a graphical interface (GUI) for an online vehicle ownership tool within a web browser application, such as Apple's Safari®, Google Android™ mobile web browser, Microsoft Internet Explorer®, etc. The web browser application may be implemented as a series of machine-readable instructions for receiving, interpreting, and displaying web page information (e.g. from web server 143) while also receiving inputs from the user.

Further, the portable device 200 also includes a communication module 235, that facilitates wireless communication for data exchange over a mobile and/or wide area network, and a user interface 240. The user interface may include devices to receive inputs from a user, such as a keyboard, touchscreen, buttons, trackballs, etc., and display devices, such as liquid crystal displays (LCD), light emitting diodes (LED), organic light-emitting diodes (OLED), ePaper displays, etc.

### Vehicle Condition Assessment

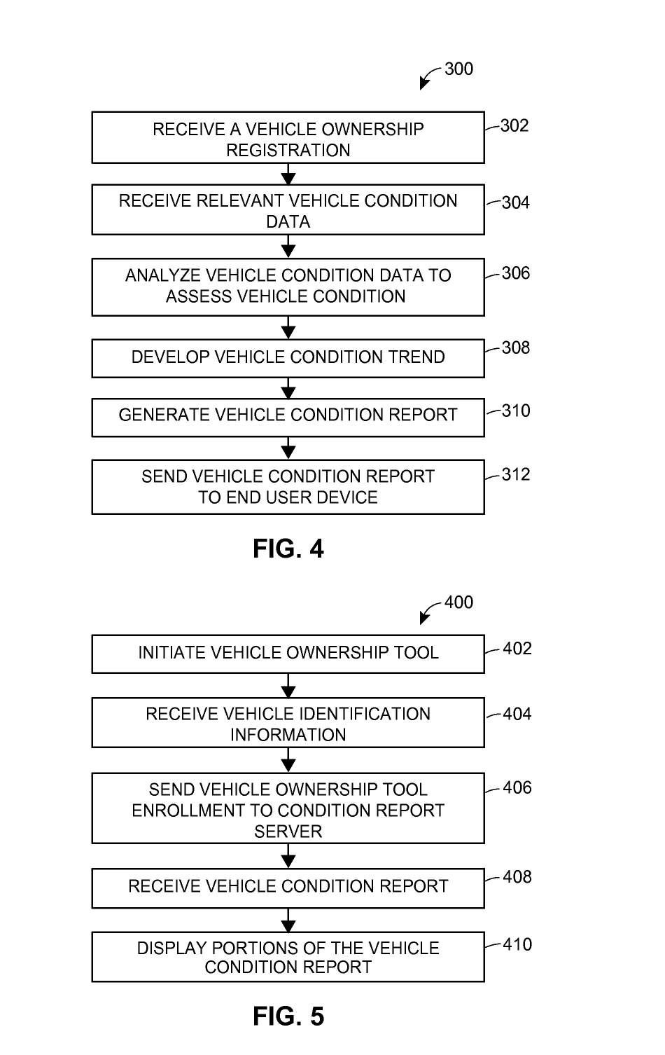

FIG. 4 is a flow diagram of an example method 300 for based on vehicle condition data. The method 300 may be implemented in the condition report server 102, for example.

To begin, a vehicle enrollment is received from an end user device (block 302). In one scenario, an owner of a vehicle may use one of the end user devices 106 to enroll a vehicle for vehicle condition reporting, as described below, by entering information identifying the vehicle, via a user interface. For example, the information identifying the vehicle may include a license plate number, license plate state, manufacturer name, model name or number, color, vehicle identification number (VIN), registered owner name, owner contact information, insurance policy number, etc. In turn, the one of the end user devices 106 may send an enrollment, including the information identifying the vehicle, to the condition report server 102 to obtain an assessment of the past, current, and/or future condition (e.g. quality or market value) of the vehicle, in the example scenario.

Upon receiving the vehicle enrollment, condition data, corresponding to the vehicle identified in the vehicle ownership tool enrollement, is retrieved from a vehicle condition database (block 304), such as condition database 115. In some implementations, the condition data may include data gathered from a variety of data sources, as described in U.S. application Ser. No. 13/897646 entitled “Systems and Methods to Identify and Profile a Vehicle Operator” and filed on May 20, 2013, the entire disclosure of which is hereby incorporated by reference herein. By way of example and without limitation, such data sources may include: (i) sensors installed in vehicles, such as braking/acceleration/cornering sensors, tire pressure sensors, cameras, microphones, engine temperature sensors, mileage sensors, clocks, etc., (ii) sensors in mobile devices (e.g. smartphones, tablet computers, geopositioning receivers, etc.), where the mobile devices are temporarily disposed in vehicles, and (iii) third party databases (e.g. public record databases, insurance databases, etc.).

In some implementations, the condition data corresponding to the vehicle may be immediately descriptive of vehicle condition or descriptive of vehicle condition after manipulation. For example, data indicating vehicle mileage, year, and previous collisions/incidents may be immediately descriptive of the condition of a vehicle. On the other hand, engine rotations per minute (RPM), braking profiles, and geographic locations are example types of data that may be descriptive of the condition of a vehicle only after manipulation. In one scenario, an analysis of engine RPM data may indicate that a vehicle is frequently used for towing a trailer, and towing a trailer may be highly correlated with vehicle depreciation and/or high maintenance costs, example factors related to vehicle condition.

The condition data, corresponding to the vehicle identified in the vehicle enrollment, may be updated or augmented with additional condition data gathered from the registered vehicle, in an implementation. For example, the condition report server 102 may use existing condition data (i.e. existing at the time of the vehicle enrollment) to make an initial assessment of vehicle condition and then use additional condition data gathered over time to establish a vehicle condition trend. The vehicle condition trend may provide a vehicle owner with early warning of potential maintenance issues, an accurate cost of ownership, vehicle depreciation information, etc. In some implementations, the additional condition data may be gathered from the same data sources as the data sources of the existing condition data and/or different data sources.

In some implementations, owners of vehicles may receive incentives for contributing condition data to be stored in a condition database. For example, car dealerships may offer more money to buy used cars that have recorded condition data over the life of the car, as compared with a car that has no recorded condition data. In another example, an insurance company may provide coupons, discounts, or other rewards to customers that contribute condition data from insured vehicles.

Returning to FIG. 4, the condition data, retrieved from a vehicle condition database, is analyzed to assess the condition of the vehicle (block 306), in an implementation. For example, the condition report server 102 may analyze the condition data to assess the condition of the vehicle in relation to quality and value (e.g. maintenance, longevity, cost of ownership, mechanical operation, aesthetic condition, etc.)

In a simple example scenario, the condition report server 102 may retrieve geopositioning data, acceleration/braking/cornering data, and maintenance history data from the condition database 115. The maintenance history data may indicate that a vehicle has a history free of frequent or severe maintenance/repair issues. However, the geopositioning data may indicate that the vehicle has primarily been driven in the “salt belt” region of the United States (a region where vehicles commonly encounter corrosion due to the use of road salt) and the acceleration/braking/cornering data may indicate erratic and severe acceleration, braking, and/or cornering (i.e. reckless driving). In such an example scenario, the condition report server 102 may assess the condition of the vehicle as relatively low quality/value because of probable current and/or future issues caused by the driving environment and driving behavior.

An owner considering only the maintenance history and general vehicle information (e.g. mileage, make, model, year, etc.) may overestimate the condition of the vehicle, in the above scenario. In contrast, the techniques of the present disclosure are able to provide an accurate assessment of vehicle condition by analyzing granular data gathered from the vehicle over time, such as the geopositioning and acceleration/braking/cornering data in the above scenario, for example.

In some implementations, the condition report server 102 may collectively or comparatively analyze the condition data to assess vehicle condition. For example, mileage data may indicate a relatively high mileage (e.g. 100,000 miles as compared with an average of 75,000 miles for cars of the same year), whereas geopositioning data may indicate that the vehicle is predominately driven in rural areas of the state of Arizona. Independently, the high mileage may indicate low quality or value. However, when combined with geopositioning data, from which one could infer mostly highway driving (i.e. rural driving) in a dry climate (Arizona), the condition report server 102 may more moderately assess the vehicle quality and value, in the example case.

The report server 102 may assess both the past and future condition of the vehicle in addition to the current condition of the vehicle, in some implementations. The report server 102 may use prediction, modeling, simulation, or other suitable algorithms to infer a condition of a vehicle at times in the past and predict conditions of a vehicle in the future, for example. A prediction algorithm (e.g. trained on reference data) may predict that a certain vehicle will need brake replacement in one year, transmission service in two years, and tire replacement in one and a half years, in an example scenario. This information is valuable to a vehicle owner in that the owner may appropriately plan for such events.

Also, the condition report server 102 may use prediction, modeling, etc. algorithms to accurately assess the current condition of a vehicle, even when condition data is not available over the entire life, or age, of the vehicle. For example, condition data may be available for only five out of ten years of the life of a vehicle. In such a case, a simulation/modeling algorithm may stitch together the available data with simulations to provide an accurate assessment of current vehicle condition.

Once the vehicle condition is assessed, vehicle condition descriptors reflecting the condition trend of the vehicle are developed (block 308). The condition descriptors may include any suitable representation or representations of the condition trend of the vehicle, in an implementation. The condition descriptors may include, by way of example: (i) scores or ratings representing relative quality, value, mechanical operation, etc., such as a score between one and one hundred or a rating of one to five stars; (ii) text statements reflecting a condition, such as “low,” “moderate,” or “high” cost of ownership, “this car may have major repair needs within two years,” etc.; (iii) graphical representations of condition information, such as graphs, plots, or charts indicating average engine temperature as a function of time, maintenance/repair events per year, etc.; (iv) images or icons, such as a thumbs up/down, caution sign icons, etc.

Next, a vehicle condition report is generated to be presented on an end user device (block 310). In some implementations, the vehicle condition report includes some or all of the condition descriptors developed at block 308. For example, the condition report server 102 may generate a vehicle condition report in the form of one or more web pages including at least some of the condition descriptors, where the web pages may be displayed via a web browser application executed on the one or more end user devices 106.

In some implementations, the vehicle condition report is interactive. For example, the condition report server 102 may develop a vehicle condition report in the form of one or more interactive web pages or in the form of content for an interactive vehicle condition reporting application. An initial web page may display a general representation of vehicle condition, such as a series of scores or ratings, and, upon customer selection of a score or rating, further or modified web pages may display more detailed information, such as graphs, tables, etc. or even portions of the raw condition data itself, for example.

Finally, the vehicle condition report is seny to an end user device for presentation to the owner of the vehicle (block 312). In some implementations, the condition report server 102 may initially send a partial vehicle condition report to the end user device, and then, based on user interaction with the report, the condition report server 102 may send additional portions of the vehicle condition report. Further, the condition report server 102 may generate and send variations of the vehicle condition report based on end user device configurations, in an implementation. For example, the condition report server may generate one variation of a vehicle condition report for a visually appealing display on a smartphone and another variation of a vehicle condition report for a visually appealing display on a tablet, laptop, or desktop computer.

### Vehicle Condition Reporting

FIG. 5 is a flow diagram of an example method 400 for reporting vehicle condition information on an end user device. The method 440 may be implemented by the one or more end user devices 106, for example.

To begin, a vehicle ownership tool is initiated (block 402). In one implementation, one of the end user devices 106 may execute a vehicle ownership tool stored in memory (e.g. the vehicle condition reporting tool 215), where the vehicle ownership tool facilitates communications with the condition report server 102 and the display of vehicle condition reports. In another implementation, a user of one of the end user devices 106 may initiate a vehicle ownership tool via a web browser application.

Next, vehicle identification information is received via a user interface (block 404), such as the user interface 240. In some implementations, one of the end user devices 106 may display a series of forms, questions, buttons, etc. to prompt a user of one of the end user devices 106 to enter vehicle identification information. For example, one of the end user devices 106 may display a text box for entering a VIN number and a “continue” button such that the user may enter the VIN number via a keyboard or touchscreen and tap or click the continue button to confirm the identification information.

In another implementation, a user of an end user device may use sensors in the device itself to automatically generate vehicle identification information. For example, a camera on a smartphone may capture an image of a license plate or scan a bar code representing a VIN number. In such a case, the end user device may analyze the automatically generated data and, in some implementations, transform the data into convenient formats (e.g. text, numbers, etc.) for vehicle identification.

Once vehicle identification information is received, a vehicle enrollment is sent to a condition report server (block 406). The vehicle enrollment includes the vehicle identification information, and, in some implementations, the vehicle enrollment includes device specific information. For example, the vehicle enrollment may include device specific information indicating device configurations (e.g. hardware, software, etc.), device users (e.g. usernames, passwords, identification numbers, etc.), device locations, etc.

Returning to FIG. 5, a vehicle condition report is received in response to the vehicle condition query (block 408). For example, the condition report server 102 may electronically communicate the vehicle condition report to one of the end user devices as web content for display in a vehicle condition reporting tool or web browser. In addition, the condition report server 102 may send the vehicle condition report via email, text message, or hyperlink, for example.

In some implementations, the condition report server 102 may use device specific information to customize vehicle condition reports. For example, the condition report server may use a device location to generate a vehicle condition report emphasizing relevant vehicle condition descriptors (e.g. through prominent display, icons, bold text, etc.).

In one scenario, an end user device may be located in an area with severe winter weather, and, as such, the condition report server may generate a vehicle condition report that emphasizes mechanical operation issues, repair issues, etc. that would be particularly relevant in cold climates (e.g. problems with a four wheel drive differential, problems starting an engine in cold weather, etc.). In another example, the condition report server 102 may customize vehicle condition reports for individual device users. In one scenario, a device user may indicate (via a user interface) that maintenance issues are not as important as vehicle aesthetic condition (e.g. paint condition, body condition, etc.). As such, the condition report server 102 may display information regarding vehicles aesthetics predominately in a vehicle condition report or analyze data related to aesthetics in more detail, for example.

In another scenario, the condition report server 102 may analyze condition data and predict that a vehicle will need replacement brake pads within a year. The condition report server 102 may also use the location of an end user device, associated with the vehicle, to advertise or recommend nearby businesses offering brake replacement services, in the example scenario. In some implementations, the condition report server 102 may communicate with third party servers, where the third party servers provide advertisements based on end user device location and vehicle condition.

Upon receiving the vehicle condition report, all or part of the vehicle condition report is displayed (block 410). For example, one of the end user devices 106 may display interactive web pages or other interactive vehicle condition content, as described with reference to FIG. 4. In some implementations, one of the end user devices 106 may download or view the vehicle condition report as a document, such as a portable document format (PDF) document , Microsoft Excel® spreadsheet, or other suitable document. For example, one of the end user device 106 may save a vehicle condition report document in computer-readable memory or print a vehicle condition report document for later viewing. Also, a user may “share” part or all of a vehicle condition report with friends, potential buyers, etc. via email, text message, hyperlink, Facebook®, etc., in some implementations

1. A computer-implemented method for reporting vehicle ownership information comprising:
receiving, via a computer network, an enrollment from a customer, wherein the enrollment includes information identifying a vehicle owned or operated by the customer;
retrieving existing condition data corresponding to the vehicle from a condition database,
wherein the existing condition data was generated while the vehicle was being operated prior to the receiving of the enrollment, and
wherein a plurality of devices inside the vehicle generated at least some of the existing condition data, the plurality of devices including at least three or more of a mobile device temporarily disposed in the operated vehicle, a geopositioning receiver, a motion sensor, a camera, or an audio sensor; gathering, via the computer network, additional condition data corresponding to the vehicle,
wherein at least some of the additional condition data is generated while the vehicle is operated by the customer after the receiving of the enrollment, and
wherein the plurality of devices inside the vehicle generates at least some of the additional condition data;
analyzing, by one or more processors, the existing condition data and the additional condition data to generate a vehicle condition trend, wherein the vehicle condition trend reflects changes in a condition of the vehicle, and wherein the condition of the vehicle includes one of a market value or trade-in value of the vehicle and an overall quality level of the vehicle;
generating, by the one or more processors, a vehicle ownership report, wherein the vehicle ownership report includes one or more visual descriptors of the vehicle condition trend; and
communicating, via the computer network, the vehicle ownership report to a remote computing device for presentation to the customer.

2. The computer-implemented method of claim 1, wherein the information identifying the vehicle includes at least one of a license plate number, license plate state, manufacturer name, year of manufacture, name of insurance company, model name or number, color, vehicle identification number (VIN), registered owner name, owner contact information, or insurance policy number.

3. The computer-implemented method of claim 1, wherein the condition of the vehicle further includes a state of mechanical operation of the vehicle.

4. The computer implemented method of claim 3, wherein the additional condition data includes one or more of indications of current or prior geographic locations, mileages of the vehicle, times, dates, behaviors of the customer while operating the vehicle, collisions in which the vehicle was involved, repairs of the vehicle, information from a vehicle title corresponding to the vehicle, usage patterns of the vehicle, recalls corresponding to the vehicle, preferences of the customer, or driving violations.

5. The computer-implemented method of claim 1, wherein at least one of the plurality of devices inside the vehicle that generates the additional condition data also generated at least some of the existing condition data.

6. The computer-implemented method of claim 1, further comprising storing, by the one or more processors, the additional condition data in the condition database.

7. The computer-implemented method of claim 6, wherein the additional condition data is stored in the condition database along with the existing condition data as a current condition data set.

8. The computer-implemented method of claim 6, wherein one or more timestamps are stored with the additional condition data identifying the time at which the additional condition data was gathered.

9. The computer-implemented method of claim 1, wherein analyzing, with one or more processors, the existing condition data and the additional condition data to establish the vehicle condition trend includes:
determining, by the one or more processors, the condition of the vehicle based on at least some of the existing condition data or the additional condition data; and
predicting at least one of a current or future market value of the vehicle or a current or future need for maintenance or repair of the vehicle.

10. (canceled)

11. The computer-implemented method of claim 1, wherein the one or more visual descriptors include one of text, image, graph, plot, chart, or table based representations of the vehicle condition trend.

12. A computer-implemented method for reporting vehicle condition information on a computing device including a display device and a user interface, the method comprising:
receiving, from a customer via the user interface, a vehicle enrollment, wherein the enrollment includes information identifying a vehicle owned or operated by the customer;
generating, by one or more processors, a vehicle condition query, wherein the vehicle condition query includes the information identifying the vehicle;
sending, via a network interface at the computing device, the vehicle condition query to a server;
receiving, via the network interface at the computing device, information indicative of a vehicle condition trend,
wherein the vehicle condition trend reflects changes in a condition of the vehicle,
wherein the condition of the vehicle includes one of a market value or trade-in value of the vehicle and an overall quality level of the vehicle, and
wherein the condition of the vehicle is based on a collective analysis of existing condition data generated by a plurality of devices inside the vehicle while the vehicle was being operated prior to receiving the vehicle enrollment and additional condition data generated by the plurality of devices inside the vehicle while the vehicle is operated after receiving the vehicle enrollment, and
wherein the plurality of devices inside the vehicle includes at least three or more of a mobile device temporarily disposed in the operated vehicle, a geopositioning receiver, a motion sensor, a camera, or an audio sensor;
rendering, by the one or more processors, an image representing of at least some of the information indicative of the vehicle condition trend; and
presenting, via the display device, the image of at least some of the information indicative of the vehicle condition trend.

13. The computer-implemented method of claim 12, wherein the information identifying the vehicle includes at least one of a license plate number, license plate state, manufacturer name, year of manufacture, name of insurance company, model name or number, color, vehicle identification number (VIN), registered owner name, owner contact information, or insurance policy number.

14. The computer-implemented method of claim 12, wherein the condition of the vehicle further includes a state of mechanical operation of the vehicle.

15. The computer implemented method of claim 14, wherein the condition data includes one or more of indications of current or prior geographic locations, mileages of the vehicle, times, dates, behaviors of the customer while operating the vehicle, collisions in which the vehicle was involved, repairs of the vehicle, information from a vehicle title corresponding to the vehicle, usage patterns of the vehicle, recalls corresponding to the vehicle, preferences of the customer, or driving violations.

16. The computer-implemented method of claim 12, wherein the information indicative of the vehicle condition trend includes at least one of:
(i) a prediction of a current or future market value of the vehicle,
(ii) a prediction of a current or future need for maintenance or repair of the vehicle,
(iii) an indication of one or more recommended points in time to buy or sell the vehicle, or
(iv) a suggestion for improving the quality or value of the vehicle.

17. A computer device for reporting vehicle ownership information, the computer device comprising:
one or more processors; and
one or more non-transitory memories coupled to the one or more processors;
wherein the one or more memories include computer executable instructions stored therein that, when executed by the one or more processors, cause the one or more processors to:
receive, via a computer network, an enrollment from a customer, wherein the enrollment includes information identifying a vehicle owned or operated by the customer;
retrieve existing condition data corresponding to the vehicle from a condition database,
wherein the existing condition data was generated while the vehicle was being operated prior to the receiving of the enrollment, and
wherein a plurality of devices inside the vehicle generated at least some of the existing condition data, the plurality of devices including at least three or more of a mobile device temporarily disposed in the operated vehicle, a geopositioning receiver, a motion sensor, a camera, or an audio sensor; gather, via the computer network, additional condition data corresponding to the vehicle,
wherein at least some of the additional condition data is generated while the vehicle is operated by the customer after the receiving of the enrollment, and
wherein the plurality of devices inside the vehicle generates at least some of the additional condition data;
analyze the existing condition data and the additional condition data to generate a vehicle condition trend, wherein the vehicle condition trend reflects changes in a condition of the vehicle, and wherein the condition of the vehicle includes one of a market value or trade-in value of the vehicle and an overall quality level of the vehicle;
generate a vehicle ownership report, wherein the vehicle ownership report includes one or more visual descriptors of the vehicle condition trend; and
communicate, via the computer network, the vehicle ownership report to a remote computing device for presentation to the customer.

18. The computer device of claim 17, wherein the condition of the vehicle further includes a state of mechanical operation of the vehicle.

19. The computer device of claim 17, wherein the computer executable instruction further cause the one or more processors to store the additional condition data in a database.

20. The computer device of claim 18, wherein the database storing the additional condition data is separate from the condition database storing the existing condition data.
